(19) United States
(12) Patent Application Publication
(10) Pub. No.: US 2022/0147816 A1
(43) Pub. Date: May 12, 2022

(54) DIVIDE-AND-CONQUER FRAMEWORK FOR QUANTILE REGRESSION

(71) Applicant: INTERNATIONAL BUSINESS MACHINES CORPORATION, Armonk, NY (US)

(72) Inventors: Hiroki Yanagisawa, Tokyo (JP); Kohei Miyaguchi, Tokyo (JP); Takayuki Katsuki, Tokyo (JP)

(21) Appl. No.: 17/093,804

(22) Filed: Nov. 10, 2020

(51) Int. Cl. G06N 3/08; G06N 3/04

(52) U.S. Cl. CPC G06N 3/08; G06N 3/04

(57) ABSTRACT

A method is presented for estimating conditional quantile values of a response variable distribution. The method includes acquiring training data with first values and second values, a list of quantile levels, a lower bound of the second values, and an upper bound of the second values and transforming the list of quantile levels into a tree-structure by recursively dividing an interval in a range between 0 and 1 into sub-intervals by using the list of quantile levels such that each node of the tree-structure is associated with a tuple of three quantile levels. The method further includes training a neural network for each node in the tree-structure and estimating a relative quantile value for each of the first values by using a first estimated quantile value as a lower bound and a second estimated quantile value as an upper bound.

### BACKGROUND

The present invention relates generally to quantile regression, and more specifically, to a divide-and-conquer framework for quantile regression.

The increasing complexity of data in research and business analytics requires versatile, robust, and scalable methods of building explanatory and predictive statistical models. Quantile regression meets these requirements by fitting conditional quantiles of the response with a general model that assumes no parametric form for the conditional distribution of the response. Quantile regression provides information that is not obtained directly from standard regression methods. Quantile regression yields valuable insights in applications such as risk management, where answers to important questions lie in modeling the tails of the conditional distribution. Quantile regression, however, can have its limitations.

### SUMMARY

In accordance with an embodiment, a method is provided for estimating conditional quantile values of a response variable distribution. The method includes acquiring training data represented as coordinates with first values and second values, a list of quantile levels, a lower bound of the second values, and an upper bound of the second values, wherein each of first values is a feature vector and each of the second values is a real number, transforming the list of quantile levels into a tree-structure by recursively dividing an interval in a range between 0 and 1 into sub-intervals by using the list of quantile levels such that each node of the tree-structure is associated with a tuple of three quantile levels, training a neural network for each node in the tree-structure in an order designated from a root node to leaf nodes within the tree-structure, estimating, via the neural network, a relative quantile value for each of the first values by using a first estimated quantile value as a lower bound and a second estimated quantile value as an upper bound, wherein a third estimated quantile value is calculated based on the lower bound first estimated value, the upper bound second estimated value, and the relative quantile value, and, in one example, displaying the relative quantile values of the first values in a graphical format on a display of a computing device.

In accordance with an embodiment, a method is provided for estimating conditional quantile values of a response variable distribution. The method includes acquiring training data represented as coordinates with first values and second values, a list of quantile levels, a lower bound of the second values, and an upper bound of the second values, wherein each of first values is a feature vector and each of the second values is a real number, transforming the list of quantile levels into a tree-structure by recursively dividing an interval in a range between 0 and 1 into sub-intervals by using the list of quantile levels such that each node of the tree-structure is associated with a tuple of three quantile levels, training a regression model for each node in the tree-structure in an order designated from a root node to leaf nodes within the tree-structure, estimating, via the regression model, a relative quantile value for each of the first values by using a first estimated quantile value as a lower bound and a second estimated quantile value as an upper bound, wherein a third estimated quantile value is calculated based on the lower bound first estimated value, the upper bound second estimated value, and the relative quantile value, and, in one example, displaying the relative quantile values of the first values in a graphical format on a display of a computing device.

A computer program product for estimating conditional quantile values of a response variable distribution is presented, the computer program product comprising a computer readable storage medium having program instructions embodied therewith, the program instructions executable by a computer to cause the computer to acquire training data represented as coordinates with first values and second values, a list of quantile levels, a lower bound of the second values, and an upper bound of the second values, wherein each of first values is a feature vector and each of the second values is a real number, transform the list of quantile levels into a tree-structure by recursively dividing an interval in a range between 0 and 1 into sub-intervals by using the list of quantile levels such that each node of the tree-structure is associated with a tuple of three quantile levels, train a neural network for each node in the tree-structure in an order designated from a root node to leaf nodes within the tree-structure, estimate, via the neural network, a relative quantile value for each of the first values by using a first estimated quantile value as a lower bound and a second estimated quantile value as an upper bound, wherein a third estimated quantile value is calculated based on the lower bound first estimated value, the upper bound second estimated value, and the relative quantile value, and, in one example, display the relative quantile values of the first values in a graphical format on a display of a computing device.

It should be noted that the exemplary embodiments are described with reference to different subject-matters. In particular, some embodiments are described with reference to method type claims whereas other embodiments have been described with reference to apparatus type claims. However, a person skilled in the art will gather from the above and the following description that, unless otherwise notified, in addition to any combination of features belonging to one type of subject-matter, also any combination between features relating to different subject-matters, in particular, between features of the method type claims, and features of the apparatus type claims, is considered as to be described within this document.

These and other features and advantages will become apparent from the following detailed description of illustrative embodiments thereof, which is to be read in connection with the accompanying drawings.

### BRIEF DESCRIPTION OF THE DRAWINGS

The invention will provide details in the following description of preferred embodiments with reference to the following figures wherein:

FIG. 1 is an exemplary diagram illustrating an artificial neural network (ANN) architecture employed in quantile regression, in accordance with an embodiment of the present invention;

FIG. 2 illustrates an exemplary neural network with training data supplied to a divide-and-conquer process employed in quantile regression, in accordance with an embodiment of the present invention;

FIG. 3 is an exemplary Fully Connected (FC) neural network illustrated with a single output and with multiple outputs employed in quantile regression, in accordance with an embodiment of the present invention;

FIG. 4 is an exemplary recurrent neural network (RNN) employed in quantile regression, in accordance with an embodiment of the present invention;

FIG. 5 is an exemplary block/flow diagram of the system implementing the divide-and-conquer process employed in quantile regression, in accordance with an embodiment of the present invention;

FIG. 6 is an illustrative example of the system of FIG. 5, in accordance with an embodiment of the present invention;

FIG. 7 is a block/flow diagram of an exemplary FC neural network with single output employing the divide-and-conquer process, in accordance with an embodiment of the present invention;

FIG. 8 is a block/flow diagram of an exemplary FC neural network with multiple outputs employing the divide-and-conquer process, in accordance with an embodiment of the present invention;

FIG. 9 is a block/flow diagram of an exemplary tree-RNN employing the divide-and-conquer process, in accordance with an embodiment of the present invention;

FIG. 10 is a block/flow diagram of an exemplary method for employing the divide-and-conquer process, in accordance with an embodiment of the present invention;

FIG. 11 is a block/flow diagram of an exemplary method outlining the training phase for the divide-and-conquer process, in accordance with an embodiment of the present invention;

FIG. 12 is a block/flow diagram of an exemplary method outlining the testing phase for the divide-and-conquer process, in accordance with an embodiment of the present invention;

FIG. 13 is a block/flow diagram of a computing method for employing the divide-and-conquer process in quantile regression, in accordance with an embodiment of the present invention;

FIG. 14 is a block/flow diagram of an exemplary cloud computing environment, in accordance with an embodiment of the present invention; and

FIG. 15 is a schematic diagram of exemplary abstraction model layers, in accordance with an embodiment of the present invention.

Throughout the drawings, same or similar reference numerals represent the same or similar elements.

### DETAILED DESCRIPTION

Exemplary embodiments in accordance with the present invention provide for employing a divide-and-conquer framework or process for quantile regression. Quantile regression is a type of regression analysis used in statistics and econometrics. Whereas the method of least squares estimates the conditional mean of the response variable across values of the predictor variables, quantile regression estimates the conditional median of the response variable. One issue, however, with quantile regression is the crossing problem, which pertains to the avoidance of non-monotone quantile values in the output. That is, the 49-percentile value must always be smaller than the 50-percentile value.

Quantiles are useful in characterizing the data distribution of evolving data sets. For example, quantiles are useful in many applications, such as in database applications, network monitoring applications, and the like. In many such applications, quantiles need to be tracked dynamically over time. In database applications, for example, operations on records in the database, e.g., insertions, updates, and deletions, change the quantiles of the data distribution. Similarly, in network monitoring applications, for example, anomalies on data streams need to be detected as the data streams change dynamically over time. Computing quantiles on demand is quite expensive, and, similarly, computing quantiles periodically can be prohibitively costly as well. Therefore, it is desirable to incrementally track quantiles of the data distribution.

Most incremental quantile estimation algorithms are based on a summary of the empirical data distribution, using either a representative sample of the distribution or a global approximation of the distribution. In such incremental quantile estimation algorithms, quantiles are computed from summary data. Disadvantageously, however, in order to obtain quantile estimates with good accuracies (especially for tail quantiles, for which the accuracy requirement tends to be higher than for non-tail quantiles), a large amount of summary information must be maintained, which tends to be expensive in terms of memory. Furthermore, for continuous data streams having underlying distributions that change over time, a large bias in quantile estimates may result since most of the summary information is out of date. By contrast, other incremental quantile estimation algorithms use stochastic approximation (SA) for quantile estimation, in which the data is viewed as being quantities from a random data distribution.

The exemplary embodiments of the present invention disclose methods and systems that alleviate such quantile estimation issues by advantageously not directly estimating each quantile. Instead, according to the exemplary embodiments, each quantile is estimated as a relative position between a lower bound value and an upper bound value. This estimation method ensures that there is no crossing problem.

It is to be understood that the present invention will be described in terms of a given illustrative architecture; however, other architectures, structures, substrate materials and process features and steps/blocks can be varied within the scope of the present invention. It should be noted that certain features cannot be shown in all figures for the sake of clarity. This is not intended to be interpreted as a limitation of any particular embodiment, or illustration, or scope of the claims.

Various illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this invention.

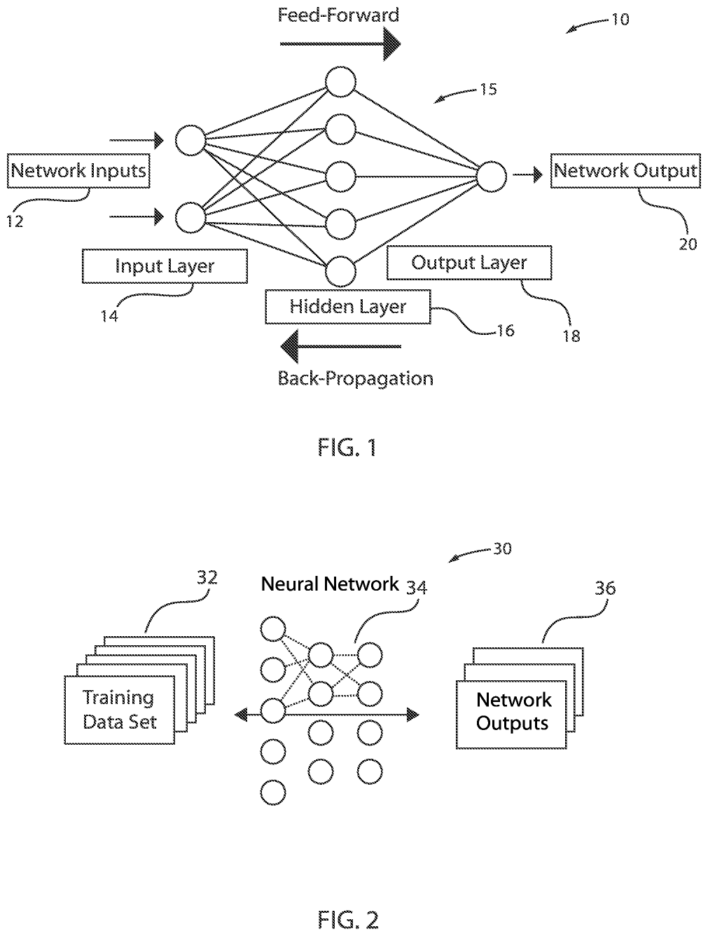

FIG. 1 is an exemplary diagram illustrating an artificial neural network (ANN) architecture employed in quantile regression, in accordance with an embodiment of the present invention.

Artificial Neural Networks (ANNs) are machine learning algorithms that are modeled after the human brain. That is, just like how the neurons in the nervous system are able to learn from past data, similarly, ANNs are able to learn from data and provide responses in the form of predictions or classifications.

ANNs are nonlinear statistical models which display a complex relationship between the inputs and outputs to discover a new pattern. A variety of tasks such as image recognition, speech recognition, machine translation, as well as medical diagnosis makes use of these ANNs. An advantage of ANNs is the fact that ANNs learn from the example data sets or training data. Most common usage of ANNs is that of a random function approximation. With these types of tools, the exemplary methods can provide for a cost-effective method of arriving at the solutions that define the distribution. ANNs are also capable of taking sample data rather than the entire dataset to provide the output result. With ANNs, the exemplary embodiments can enhance existing data analysis techniques owing to their advanced predictive capabilities.

In FIG. 1, an input layer 14 is the first layer of an ANN 10 that receives the input data 12 in the form of various texts, numbers, audio files, image pixels, etc. In the middle of the ANN 10 are the hidden layers 16. There can be a single hidden layer, as in the case of a perceptron or multiple hidden layers. These hidden layers 16 perform various types of mathematical computations on the input data 12 and recognize the patterns. In the output layer 18, results 20 are obtained through computations performed by the middle layer 16. The input layer 14, hidden layers 16, and output layer 18 can be designated as neural network 15.

In the ANN 10, there are multiple parameters and hyperparameters that affect the performance of the model. The output of ANNs is mostly dependent on these parameters. Some of these parameters are weights, biases, learning rate, batch size etc. Each node in the ANN 10 has some weight. A transfer function can be used to calculate the weighted sum of the inputs and the bias. After the transfer function has calculated the sum, the activation function obtains the result. Based on the output received, the activation functions fire the appropriate result from the node. Based on the value that the node has fired, the final output 20 is obtained. Then, using the error functions, the discrepancies are calculated between the predicted output and resulting output and the weights of the neural network 15 are adjusted through a process known as backpropagation. The exemplary embodiments can employ such ANN 10 to implement the divide-and-conquer algorithm for quantile regression.

FIG. 2 illustrates an exemplary neural network with training data supplied to a divide-and-conquer process employed in quantile regression, in accordance with an embodiment of the present invention.

In FIG. 2, a neural network 30 employs training data 32 to train the neural network with a known dataset and use the trained neural network to provide network outputs 36. Size and parameters of the neural network, size of the training dataset, and computational horsepower available together determine the amount of time needed for training.

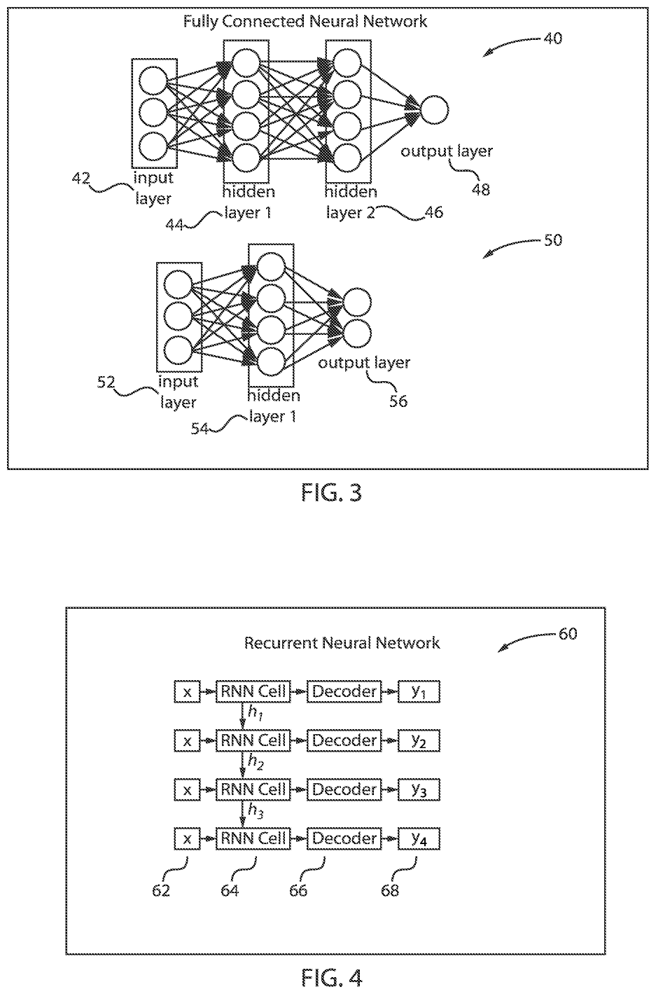

FIG. 3 is an exemplary Fully Connected (FC) neural network illustrated with a single output and with multiple outputs employed in quantile regression, in accordance with an embodiment of the present invention.

The FC layer is a traditional Multi-Layer Perceptron that uses a sigmoid activation function in the output layer. The term “Fully Connected” implies that every neuron in the previous layer is connected to every neuron on the next layer. Basically, a FC layer looks at what high level features most strongly correlate to a particular class and has particular weights so that when the method computes the products between the weights and the previous layer, the method outputs the correct probabilities for the different classes.

The output value from the FC layer is between 0 and 1. This is ensured by using the sigmoid function as the activation function in the output layer of the FC layer. The sigmoid function takes a vector of arbitrary real-valued scores and transforms it to a vector of values between zero and one.

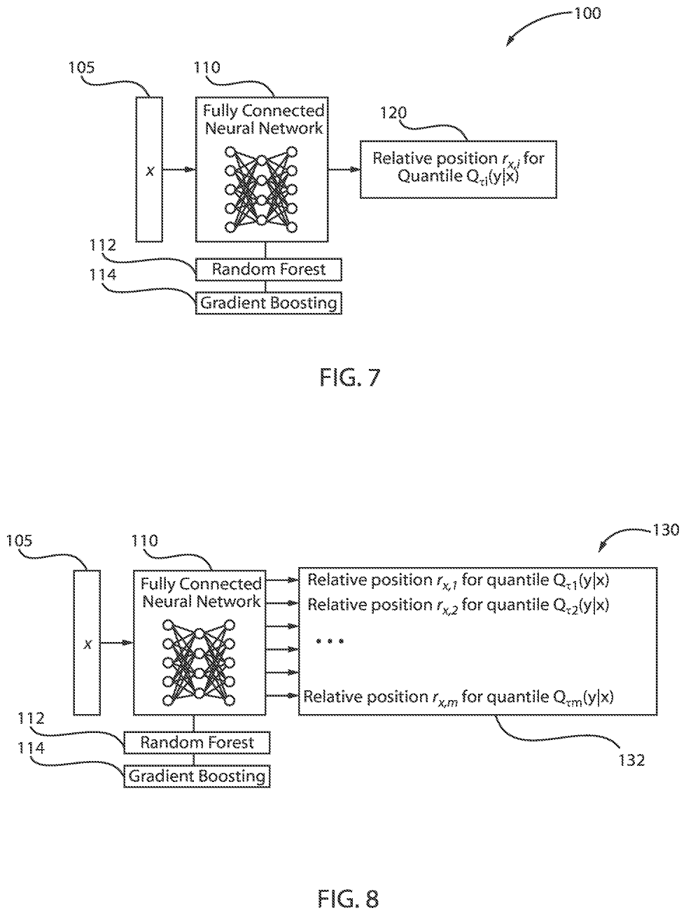

With further reference to FIG. 3, FC neural network 40 is shown including a single output and FC neural network 50 is shown including multiple outputs. FC neural network 40 thus includes an input layer 42, hidden layers 44, 46, and a single output layer 48. FC neural network 50 thus includes an input layer 52, a hidden layer 54, and multiple output layers 56. The divide-and-conquer algorithm for quantile regression of the exemplary embodiments can be implemented with both FC neural network 40 and FC neural network 50, as described in detail below with reference to FIGS. 7 and 8.

FIG. 4 is an exemplary recurrent neural network (RNN) employed in quantile regression, in accordance with an embodiment of the present invention.

The idea behind RNNs is to make use of sequential information. In a traditional neural network, it is assumed that all inputs and outputs are independent of each other. But for many tasks that's not a feasible premise. If the next word in a sentence needs to be predicted, it is beneficial to know which words came before it. RNNs are called recurrent because RNNs perform the same task for every element of a sequence, with the output being depended on the previous computations. In other words, RNNs have a “memory,” which captures information about what has been calculated so far. In theory RNNs can make use of information in arbitrarily long sequences, but in practice they are limited to looking back only a few steps.

RNNs thus take into account what happened previously and RNNs share parameters and/or weights. In FIG. 4, the RNN 60 includes a plurality of inputs 62 and a plurality of RNN cells 64 that receive the plurality of inputs 62 and process the hidden states (h). The hidden states are fed into the decoders 66, which output y (68). Thus, vector x can be referred to as the input to each hidden state for each element in the input sequence. Vector h can be referred to as the output of the hidden state after the activation function has been applied to the hidden nodes.

Therefore, RNNs can model sequence of data so that each sample can be assumed to be dependent on previous ones and RNNs are even used with convolutional layers to extend the effective pixel neighborhood. However, RNNs have certain disadvantages, such as gradient vanishing and exploding problems, there is difficulty in training RNNs, and RNNs cannot process very long sequences if using tanh or ReLU as an activation function. In such cases, LSTM networks can be used.

Long Short-Term Memory (LSTM) networks are a type of recurrent neural network capable of learning order dependence in sequence prediction problems. This is a behavior required in complex problem domains like machine translation, speech recognition, and more.

A common LSTM unit includes a cell, an input gate, an output gate and a forget gate. The cell remembers values over arbitrary time intervals and the three gates regulate the flow of information into and out of the cell. LSTM networks are well-suited to classifying, processing and making predictions based on time series data, since there can be lags of unknown duration between important events in a time series. LSTMs were developed to deal with the vanishing gradient problem that can be encountered when training traditional RNNs. The advantage of an LSTM cell compared to a common recurrent unit is its cell memory unit. The cell vector has the ability to encapsulate the notion of forgetting part of its previously stored memory, as well as to add part of the new information.

Therefore, LSTMs make small modifications to the information by multiplications and additions. With LSTMs, the information flows through a mechanism known as cell states. This way, LSTMs can selectively remember or forget things. The information at a particular cell state has three different dependencies. These dependencies can be generalized to any problem as the previous cell state (e.g., the information that was present in the memory after the previous time step), the previous hidden state (e.g., this is the same as the output of the previous cell), and the input at the current time step (e.g., the new information that is being fed in at that moment). The exemplary embodiments of the present invention can implement RNNs, as well as LSTMs, or any variants thereof to implement the divide-and-conquer algorithm for quantile regression.

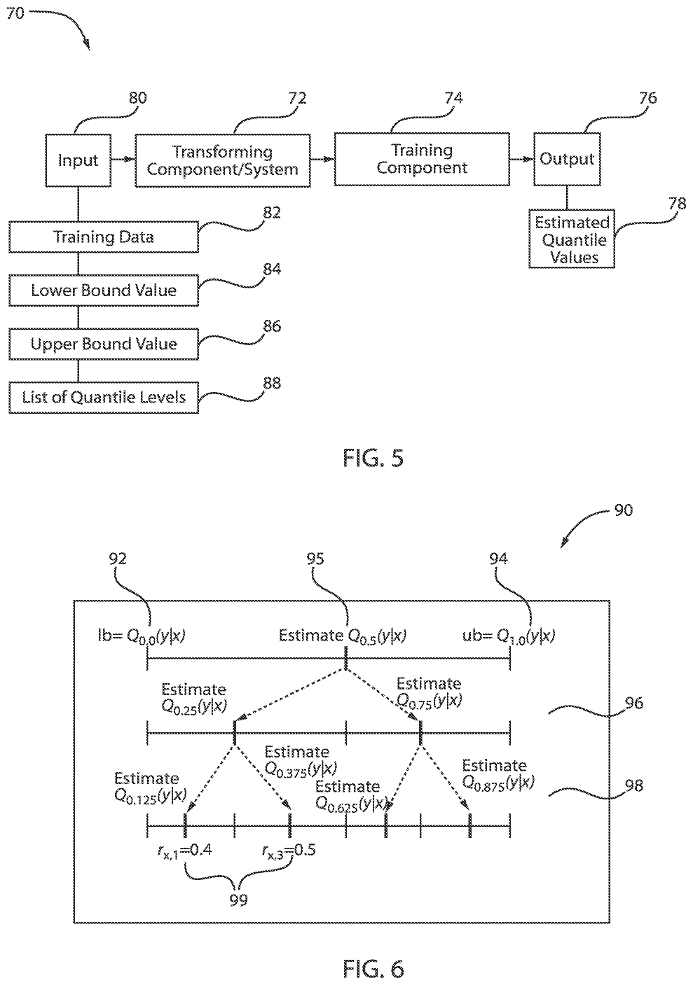

FIG. 5 is an exemplary block/flow diagram of the system implementing the divide-and-conquer process employed in quantile regression, in accordance with an embodiment of the present invention.

The system 70 receives input 80. The input 80 includes training data 82, a lower bound value 84, an upper bound value 86, and a list of quantile levels 88. The input 80 is fed into a transforming component 72 and a training component 74. The output 76 includes the estimated quantile levels 78.

The training data 82 can be designated as D={(x1, y1), (x2, y2), . . . , (xn, yn)}, the lower bound 84 can be designated as lb=(0.0-quantile) of {y1, y2, . . . , yn}, the upper bound can be designated as ub=(1.0-quantile) of {y1, y2, . . . , yn}, and the list of quantile levels 88 can be designated as tau_list=[τ₁, τ₂, . . . , τₘ]. The estimated quantile values 78 can be designated as [q₁, q₂, . . . , qₘ], where each qⱼ is a simplified notation of Q_{τ}_{ⱼ}(y|x).

The exemplary embodiments employ an algorithm where the estimate is give as:

estimate_NN(D, lbᵢ, ubₖ, τⱼ), where this procedure is implemented as a neural network (or some other regression model such as random forest and gradient boosting).

The algorithm estimates Q_{τ}_{ⱼ}(y|x) (τⱼ-quantile) in D under the condition that lbᵢ is τᵢ-quantile and ubₖ is τₖ-quantile for some i<j<k.

The algorithm can be given as:

```
Algorithm: estimate_quantiles(D, lb, ub, tau_list)
  D: training data
  lb: lower bound
  ub: upper bound
  tau_list: list of rᵢ s
begin
  if (length of tau_list) == 1 then
    return estimate_NN(D, lb, ub, tau_list[1])
  L = length of tau_list
  j = L/2 // j can be an arbitrary number between 1 and L
  qⱼ = esitimate_NN(D, lb, ub, tau_list[j]) // estimate Qᵣ_{ⱼ}(y|x)
  [q₁, q₂, . . . , qⱼ₋₁ ] = estimate_quantiles(D, lb, qⱼ, tau_list[1, 2, . . . ,
  j − 1])
  [q₁₊₁, . . . , q_{L}] = estimate_quantiles(D, qⱼ, ub, tau_list[j + 1, . . . , L])
  return [q₁, q₂, . . . , q_{L}]
end
```

FIG. 6 is an illustrative example 90 of the system of FIG. 5, in accordance with an embodiment of the present invention.

A given tau_list can be, e.g.: tau_list=[0.125, 0.25, 0.375, 0.5, 0.625, 0.75, 0.875].

In the exemplary embodiments, each quantile Q_{τ}_{ⱼ}(y|x) is not directly estimated.

Instead, each Q_{τ}_{ⱼ}(y|x) is estimated as the relative position r_{x,j} between lbᵢ (e.g., quantile Q_{τ}_{ᵢ}(y|x)) and ubₖ (i.e., quantile Q_{τ}_{ₖ}(y|x)), where r_{x,j}=0 corresponds to Q_{τ}_{ⱼ}(y|x)=Q_{τ}_{ᵢ}(y|x) and r_{x,j}=1 corresponds to Q_{τ}_{ⱼ}(y|x)=Q_{τ}_{ₖ}(y|x).

This framework or process of the exemplary embodiments ensures that there exists no crossing problem by restricting the range of each r_{x,j} in [0,1]. The lower bound (92), the upper bound (94), and the estimate 95 are shown on the first level. The second level 96 illustrates further estimates and the third level 98 illustrates even further estimates to output result 99. Result 99 refers to the relative position between an upper bound 94 and a lower bound 92 of a quantile.

FIG. 7 is a block/flow diagram 100 of an exemplary FC neural network with single output employing the divide-and-conquer process, in accordance with an embodiment of the present invention.

For the FC neural network with single output (FCN-single), the neural network is used multiple times for every tau in [τ₁, τ₂, . . . , τₘ]. In one instance, input 105 (x) is received by the FC neural network 110 to process and output a single relative position r_{x,i} (120) for quantile Q_{τ}_{ᵢ}(y|x). In alternative embodiments, the FC neural network 110 can be replaced with a random forest regression model 112 or a gradient boosting regression model 114.

Random forest 112 is a supervised learning algorithm which uses an ensemble learning method for classification and regression. Random forest is a bagging technique and not a boosting technique. The trees in random forests are run in parallel. There is no interaction between these trees while building the trees. Random forest operates by constructing a multitude of decision trees at training time and outputting the class that is the mode of the classes (classification) or mean prediction (regression) of the individual trees.

Gradient boosting 114, on the other hand, is a machine learning technique for regression and classification problems, which produces a prediction model in the form of an ensemble of weak prediction models, usually decision trees. Gradient boosting builds the model in a stage-wise manner and gradient boosting generalizes them by allowing optimization of an arbitrary differentiable loss problem. In other words, boosting is a method of converting weak learners into strong learners. In boosting, each new tree is a fit on a modified version of the original data set. The exemplary embodiments of the present invention can implement regression models, such as random forest 112 and gradient boosting 114, or any variants thereof to implement the divide-and-conquer algorithm for quantile regression.

FIG. 8 is a block/flow diagram 130 of an exemplary FC neural network with multiple outputs employing the divide-and-conquer process, in accordance with an embodiment of the present invention.

For the FC neural network with multiple output (FCN-multi), the outputs and the calculation of the loss function are configured to be consistent with the divide-and-conquer algorithm. In one instance, input 105 (x) is received by the FC neural network 110 to process and output multiple relative positions rₓ₁, rₓ₂ . . . r_{x,m} (132) for quantile Q_{τ}_{ᵢ}(y|x). In alternative embodiments, the FC neural network 110 can be replaced with a random forest regression model 112 or a gradient boosting regression model 114, as noted above for the FC neural network with a single output (FCN-single).

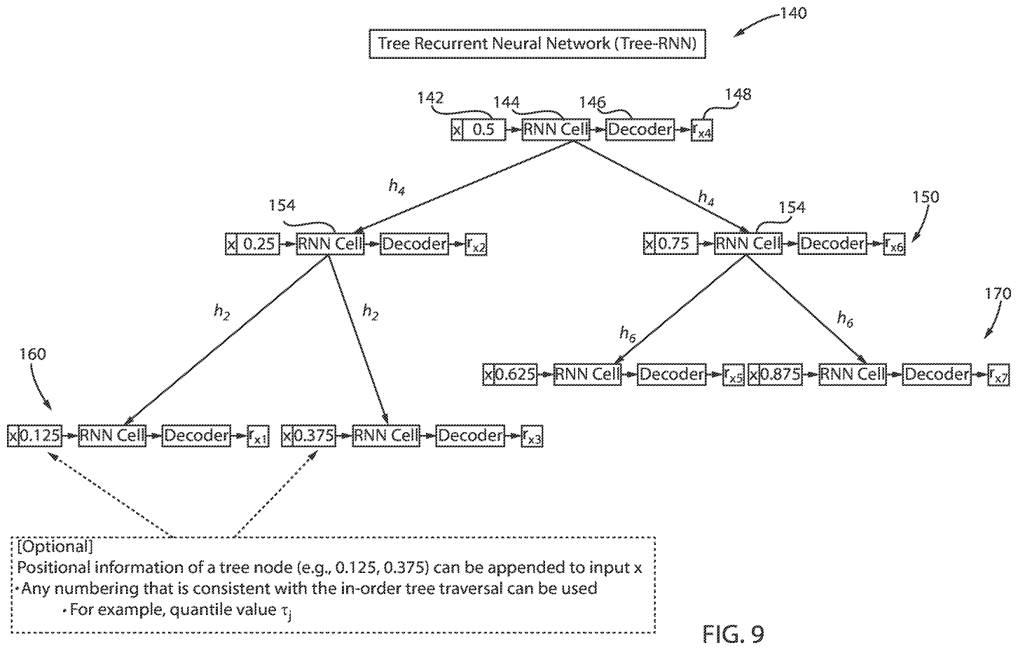

FIG. 9 is a block/flow diagram 140 of an exemplary tree-RNN employing the divide-and-conquer process, in accordance with an embodiment of the present invention.

For the tree Recurrent Neural Network (Tree-RNN), which is an extension of FCN-multi, RNN cells share weights, whereas decoders do not share weights. In one instance, the input 142 is received by the RNN cell 144 and fed into the decoder 146 to receive the relative position 148 as an output. The hidden layers, h₄, from the RNN cell 144 are fed into the next branches 150. The RNN cells 154 then feed the hidden layers, h₂ and h₆, into the next branches 160, 170, respectively.

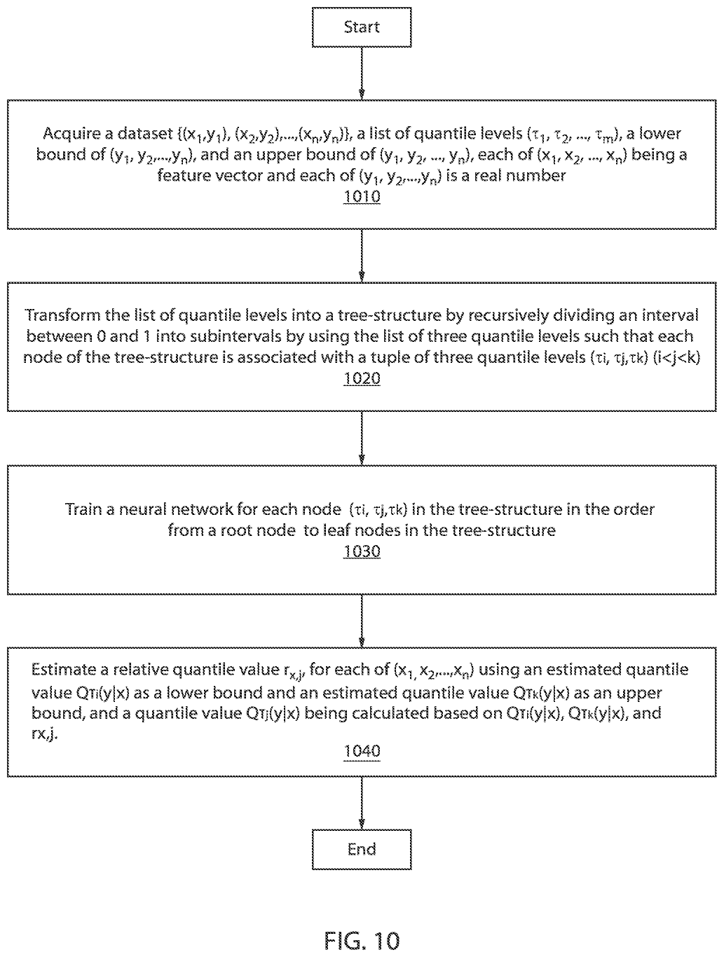

FIG. 10 is a block/flow diagram of an exemplary method for employing the divide-and-conquer process, in accordance with an embodiment of the present invention.

At block 1010, acquire a dataset {(x₁, y₁), (x₂, y₂), . . . , (xₙ, yₙ)}, a list of quantile levels (τ₁, τ₂, . . . , τₘ), a lower bound of (y₁, y₂, . . . , yₙ), and an upper bound of (y₁, y₂, . . . , yₙ), each of (x₁, x₂, . . . , xₙ) being a feature vector and each of (y₁, y₂, . . . , yₙ) is a real number.

At block 1020, transform the list of quantile levels into a tree-structure by recursively dividing an interval between 0 and 1 into subintervals by using the list of quantile levels such that each node of the tree-structure is associated with a tuple of three quantile levels (τᵢ, τⱼ, τₖ) (i<j<k).

At block 1030, train a neural network for each node (τᵢ, τⱼ, τₖ) in the tree-structure in the order from a root node to leaf nodes in the tree-structure.

At block 1040, estimate a relative quantile value r_{x,j} for each of (x₁, x₂, . . . , xₙ) using an estimated quantile value Q_{τ}_{ⱼ}(y|x) as a lower bound and an estimated quantile value Q_{τ}_{ₖ}(y|x) as an upper bound, and a quantile value Q_{τ}_{ⱼ}(y|x) being calculated based on Q_{τ}_{ᵢ}(y|x), Q_{τ}_{ₖ}(y|x), and r_{x,j}.

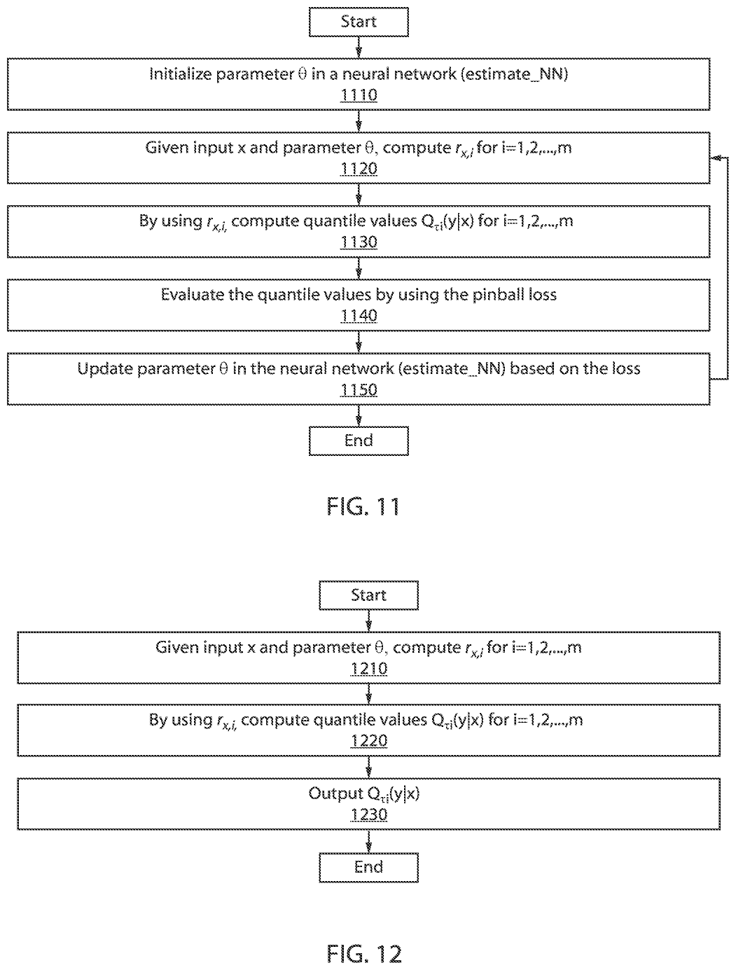

FIG. 11 is a block/flow diagram of an exemplary method outlining the training phase for the divide-and-conquer process, in accordance with an embodiment of the present invention.

At block 1110, initialize parameter θ in a neural network (estimate_NN).

At block 1120, given input x and parameter θ, compute r_{x,i} for i=1,2, . . . , m.

At block 1130, by using r_{x,i}, compute quantile values Q_{τ}_{ᵢ}(y|x) for i=1,2, . . . , m.

At block 1140, evaluate the quantile values by using the pinball loss.

At block 1150, update parameter θ in the neural network (estimate_NN) based on the loss.

FIG. 12 is a block/flow diagram of an exemplary method outlining the testing phase for the divide-and-conquer process, in accordance with an embodiment of the present invention.

At block 1210, given input x and the trained parameter θ, compute r_{x,i} for i=1,2, . . . , m.

At block 1220, by using r_{x,i}, compute quantile values Q_{τ}_{ᵢ}(y|x) for i=1,2, . . . , m.

At block 1230, output Q_{τ}_{ᵢ}(y|x).

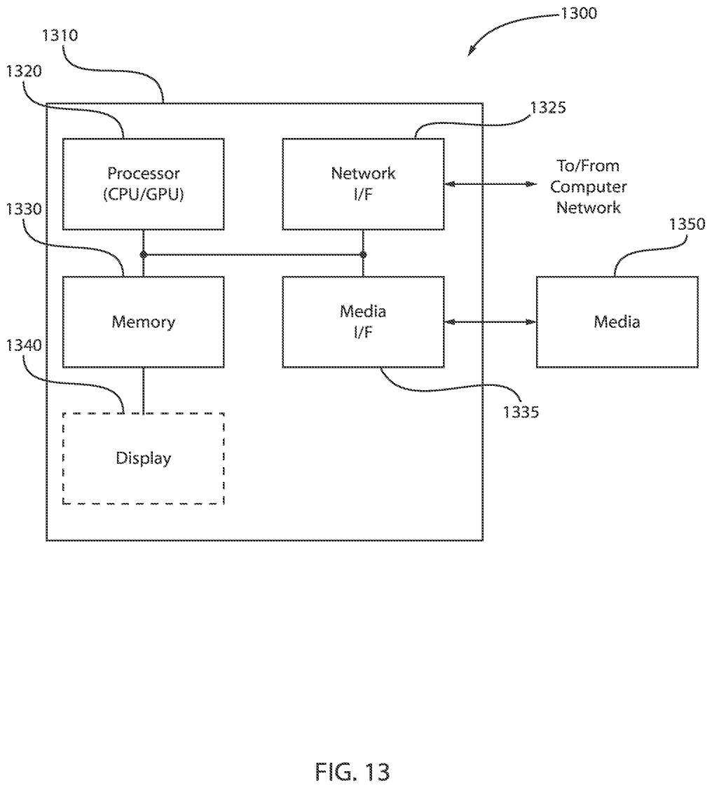

FIG. 13 is a block/flow diagram of a computing method for employing the divide-and-conquer process in quantile regression, in accordance with an embodiment of the present invention.

A block diagram is shown of an apparatus 1300 for implementing one or more of the methodologies presented herein.

Apparatus 1300 includes a computer system 1310 and removable media 1350. Computer system 1310 includes a CPU device and a GPU device collectively referred to as 1320, a network interface 1325, a memory 1330, a media interface 1335 and an optional display 1340. Network interface 1325 allows computer system 1310 to connect to a network, while media interface 1335 allows computer system 1310 to interact with media, such as a hard drive or removable media 1350.

CPU/GPU 1320 can be configured to implement the methods, steps, and functions disclosed herein. The memory 1330 could be distributed or local and the processor CPU/GPU 1320 could be distributed or singular. The memory 1330 could be implemented as an electrical, magnetic or optical memory, or any combination of these or other types of storage devices. Moreover, the term “memory” should be construed broadly enough to encompass any information able to be read from, or written to, an address in the addressable space accessed by CPU/GPU 1320. With this definition, information on a network, accessible through network interface 1325, is still within memory 1330 because the processor device 1320 can retrieve the information from the network. It should be noted that each distributed processor that makes up CPU/GPU 1320 generally includes its own addressable memory space. It should also be noted that some or all of computer system 1310 can be incorporated into an application-specific or general-use integrated circuit.

Optional display 1340 is any type of display suitable for interacting with a human user of apparatus 1300. Generally, display 1340 is a computer monitor or other similar display.

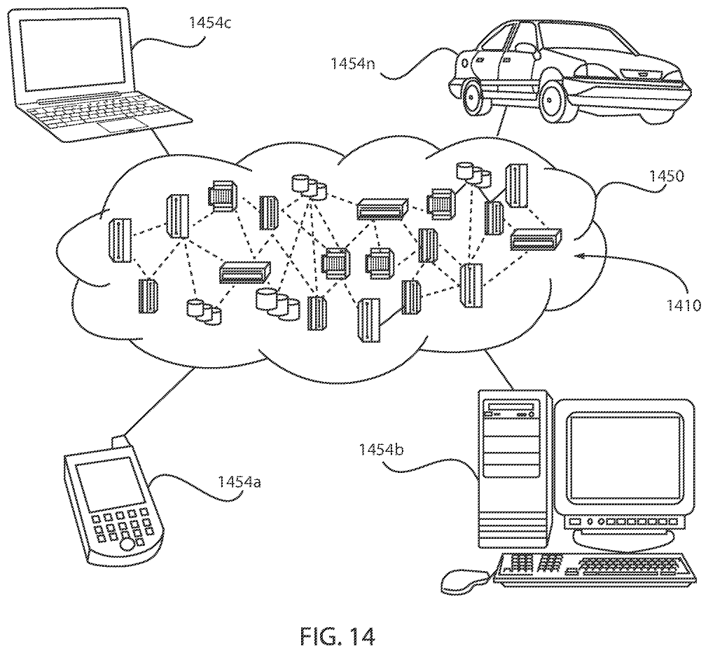

FIG. 14 is a block/flow diagram of an exemplary cloud computing environment, in accordance with an embodiment of the present invention.

It is to be understood that although this invention includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model can include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but can be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It can be managed by the organization or a third party and can exist on-premises or off-premises.

Community cloud: the cloud infrastructure is shared by several organizations and supports a specific community that has shared concerns (e.g., mission, security requirements, policy, and compliance considerations). It can be managed by the organizations or a third party and can exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 14, illustrative cloud computing environment 1450 is depicted for enabling use cases of the present invention. As shown, cloud computing environment 1450 includes one or more cloud computing nodes 1410 with which local computing devices used by cloud consumers, such as, for example, personal digital assistant (PDA) or cellular telephone 1454A, desktop computer 1454B, laptop computer 1454C, and/or automobile computer system 1454N can communicate. Nodes 1410 can communicate with one another. They can be grouped (not shown) physically or virtually, in one or more networks, such as Private, Community, Public, or Hybrid clouds as described hereinabove, or a combination thereof. This allows cloud computing environment 1450 to offer infrastructure, platforms and/or software as services for which a cloud consumer does not need to maintain resources on a local computing device. It is understood that the types of computing devices 1454A-N shown in FIG. 14 are intended to be illustrative only and that computing nodes 1410 and cloud computing environment 1450 can communicate with any type of computerized device over any type of network and/or network addressable connection (e.g., using a web browser).

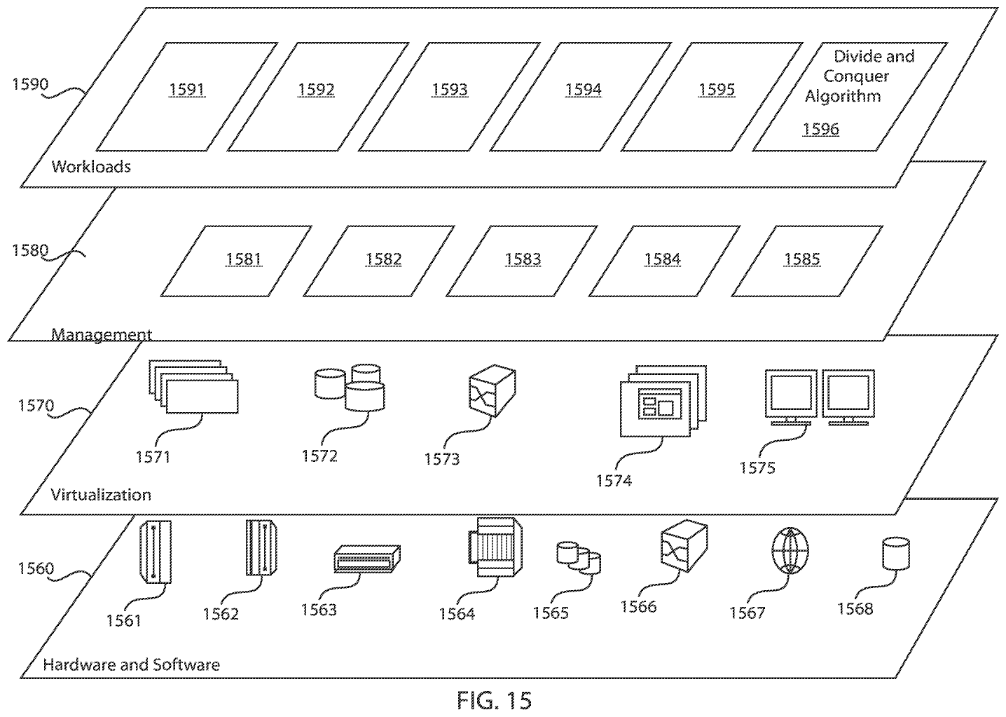

FIG. 15 is a schematic diagram of exemplary abstraction model layers, in accordance with an embodiment of the present invention. It should be understood in advance that the components, layers, and functions shown in FIG. 15 are intended to be illustrative only and embodiments of the invention are not limited thereto. As depicted, the following layers and corresponding functions are provided:

Hardware and software layer 1560 includes hardware and software components. Examples of hardware components include: mainframes 1561; RISC (Reduced Instruction Set Computer) architecture based servers 1562; servers 1563; blade servers 1564; storage devices 1565; and networks and networking components 1566. In some embodiments, software components include network application server software 1567 and database software 1568.

Virtualization layer 1570 provides an abstraction layer from which the following examples of virtual entities can be provided: virtual servers 1571; virtual storage 1572; virtual networks 1573, including virtual private networks; virtual applications and operating systems 1574; and virtual clients 1575.

In one example, management layer 1580 can provide the functions described below. Resource provisioning 1581 provides dynamic procurement of computing resources and other resources that are utilized to perform tasks within the cloud computing environment. Metering and Pricing 1582 provide cost tracking as resources are utilized within the cloud computing environment, and billing or invoicing for consumption of these resources. In one example, these resources can include application software licenses. Security provides identity verification for cloud consumers and tasks, as well as protection for data and other resources. User portal 1583 provides access to the cloud computing environment for consumers and system administrators. Service level management 1584 provides cloud computing resource allocation and management such that required service levels are met. Service Level Agreement (SLA) planning and fulfillment 1585 provide pre-arrangement for, and procurement of, cloud computing resources for which a future requirement is anticipated in accordance with an SLA.

Workloads layer 1590 provides examples of functionality for which the cloud computing environment can be utilized. Examples of workloads and functions which can be provided from this layer include: mapping and navigation 1591; software development and lifecycle management 1592; virtual classroom education delivery 1593; data analytics processing 1594; transaction processing 1595; and a divide-and-conquer algorithm 1596 in cloud servers.

As used herein, the terms “data,” “content,” “information” and similar terms can be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, the data can be received directly from the another computing device or can be received indirectly via one or more intermediary computing devices, such as, for example, one or more servers, relays, routers, network access points, base stations, and/or the like.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The present invention can be a system, a method, and/or a computer program product. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention can be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions can be provided to at least one processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks or modules. These computer readable program instructions can also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks or modules.

The computer readable program instructions can also be loaded onto a computer, other programmable data processing apparatus, or other device to cause a series of operational blocks/steps to be performed on the computer, other programmable apparatus or other device to produce a computer implemented process, such that the instructions which execute on the computer, other programmable apparatus, or other device implement the functions/acts specified in the flowchart and/or block diagram block or blocks or modules.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which includes one or more executable instructions for implementing the specified logical function(s). In some alternative implementations, the functions noted in the blocks can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This can be extended, as readily apparent by one of ordinary skill in this and related arts, for as many items listed.

Having described preferred embodiments of systems and methods for employing a divide-and-conquer algorithm in quantile regression (which are intended to be illustrative and not limiting), it is noted that modifications and variations can be made by persons skilled in the art in light of the above teachings. It is therefore to be understood that changes may be made in the particular embodiments described which are within the scope of the invention as outlined by the appended claims. Having thus described aspects of the invention, with the details and particularity required by the patent laws, what is claimed and desired protected by Letters Patent is set forth in the appended claims.

1. A method for estimating conditional quantile values of a response variable distribution, the method comprising:
acquiring training data represented as coordinates with first values and second values, a list of quantile levels, a lower bound of the second values, and an upper bound of the second values, wherein each of first values is a feature vector and each of the second values is a real number;
transforming the list of quantile levels into a tree-structure by recursively dividing an interval in a range between 0 and 1 into sub-intervals by using the list of quantile levels such that each node of the tree-structure is associated with a tuple of three quantile levels;
training a neural network for each node in the tree-structure in an order designated from a root node to leaf nodes within the tree-structure; and
estimating, via the neural network, a relative quantile value for each of the first values by using a first estimated quantile value as a lower bound and a second estimated quantile value as an upper bound, wherein a third estimated quantile value is calculated based on the lower bound first estimated value, the upper bound second estimated value, and the relative quantile value.

2. The method of claim 1, wherein a tree recurrent neural network (RNN) is employed.

3. The method of claim 2, a tree long short-term memory (LSTM) is used as a cell in the tree-RNN.

4. The method of claim 1, wherein the neural network is a fully connected neural network with a single output or a fully connected neural network with multiple outputs.

5. The method of claim 1, wherein, in a training phase, the estimated quantile values are evaluated by using a pinball loss.

6. The method of claim 1, wherein the relative quantile values of the first values are displayed in a graphical format on a display of a computing device.

7. The method of claim 6, wherein the graphical format of the relative quantile values illustrates an absence of non-monotone quantile values.

8. A method for estimating conditional quantile values of a response variable distribution, the method comprising:
acquiring training data represented as coordinates with first values and second values, a list of quantile levels, a lower bound of the second values, and an upper bound of the second values, wherein each of first values is a feature vector and each of the second values is a real number;
transforming the list of quantile levels into a tree-structure by recursively dividing an interval in a range between 0 and 1 into sub-intervals by using the list of quantile levels such that each node of the tree-structure is associated with a tuple of three quantile levels;
training a regression model for each node in the tree-structure in an order designated from a root node to leaf nodes within the tree-structure; and
estimating, via the regression model, a relative quantile value for each of the first values by using a first estimated quantile value as a lower bound and a second estimated quantile value as an upper bound, wherein a third estimated quantile value is calculated based on the lower bound first estimated value, the upper bound second estimated value, and the relative quantile value.

9. The method of claim 8, wherein the regression model is a random forest regression model.

10. The method of claim 8, wherein the regression model is a gradient boosting regression model.

11. The method of claim 8, wherein, in a training phase, the estimated quantile values are evaluated by using a pinball loss.

12. The method of claim 11, wherein the relative quantile values of the first values are displayed in a graphical format on a display of a computing device.

13. The method of claim 12, wherein the graphical format of the relative quantile values illustrates an absence of non-monotone quantile values.

14. A computer program product for estimating conditional quantile values of a response variable distribution, the computer program product comprising a computer readable storage medium having program instructions embodied therewith, the program instructions executable by a computer to cause the computer to:
acquire training data represented as coordinates with first values and second values, a list of quantile levels, a lower bound of the second values, and an upper bound of the second values, wherein each of first values is a feature vector and each of the second values is a real number;
transform the list of quantile levels into a tree-structure by recursively dividing an interval in a range between 0 and 1 into sub-intervals by using the list of quantile levels such that each node of the tree-structure is associated with a tuple of three quantile levels;
train a neural network for each node in the tree-structure in an order designated from a root node to leaf nodes within the tree-structure; and
estimate, via the neural network, a relative quantile value for each of the first values by using a first estimated quantile value as a lower bound and a second estimated quantile value as an upper bound, wherein a third estimated quantile value is calculated based on the lower bound first estimated value, the upper bound second estimated value, and the relative quantile value.

15. The computer program product of claim 14, wherein a tree recurrent neural network (RNN) is employed.

16. The computer program product of claim 15, a tree long short-term memory (LSTM) is used as a cell in the tree-RNN.

17. The computer program product of claim 14, wherein the neural network is a fully connected neural network with a single output or a fully connected neural network with multiple outputs.

18. The computer program product of claim 14, wherein, in a training phase, the estimated quantile values are evaluated by using a pinball loss.

19. The computer program product of claim 14, wherein the relative quantile values of the first values are displayed in a graphical format on a display of a computing device.

20. The computer program product of claim 19, wherein the graphical format of the relative quantile values illustrates an absence of non-monotone quantile values.
